(19) United States
(12) Patent Application Publication
(10) Pub. No.: US 2005/0099998 A1
(43) Pub. Date: May 12, 2005

(54) System and method for establishing mobile station-to-mobile station packet data calls between mobile stations in different wireless networks

(75) Inventor: William Joseph Semper, Richardson, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 10/703,700

(22) Filed: Nov. 7, 2003

(51) Int. Cl. H04L 12/66

(52) U.S. Cl. 370/352; 370/395.2

(57) ABSTRACT

A method of establishing a packet data session from an originating mobile station (MS) to a terminating mobile station (MS). The method comprises the steps of: i) receiving in an originating base station (BS) of a first wireless network a packet data connection request transmitted by the originating MS; ii) transmitting the terminating MS phone number from the originating BS to an originating mobile switching center (MSC) of the first wireless network; iii) transmitting a first message containing the terminating MS phone number from the originating MSC to a terminating mobile switching center (MSC) of a second wireless network via a switched telephone network; and iv) transmitting a second message from the terminating MSC to the terminating MS via a terminating base station of the second wireless network, the second message informing the terminating MS that a packet data session with the originating mobile station is being established.

### CROSS-REFERENCE TO RELATED APPLICATIONS

The present invention is related to those disclosed in
1) U.S. patent application Ser. No. 10/695,595, entitled “System And Method For Performing Handoffs Of Mobile Station-To-Mobile Station Packet Data Calls In A Wireless Network,” filed on Oct. 28, 2003; and
2) U.S. patent application Ser. No. 10/695,232, entitled “System And Method For Establishing Mobile Station-To-Mobile Station Packet Data Calls Directly Between Base Stations Of A Wireless Network,” filed on Oct. 28, 2003.

The subject matter disclosed in each of patent application Ser. Nos. 10/695,595 and 10/695,232 is hereby incorporated by reference into the present application as if fully set forth herein.

### TECHNICAL FIELD OF THE INVENTION

The present invention relates to wireless communication systems and, more specifically, to a system and a related method for making packet data calls between mobile stations in a wireless network.

### BACKGROUND OF THE INVENTION

Wireless communication systems have become ubiquitous in society. Business and consumers use a wide variety of fixed and mobile wireless terminals, including cell phones, pagers, Personal Communication Services (PCS) systems, and fixed wireless access devices (i.e., vending machine with cellular capability). Wireless service providers continually try to create new markets for wireless devices and expand existing markets by making wireless devices and services cheaper and more reliable. The price of wireless devices has decreased to the point where these devices are affordable to nearly everyone and the price of a wireless device is only a small part of the total cost to the user (i.e., subscriber). To continue to attract new customers, wireless service providers are implementing new services, especially digital data services that, for example, enable a user to browse the Internet and to send and receive e-mail.

Subscribers have shown great interest in using high-speed applications between mobile stations in wireless networks. Many of these high-speed applications (e.g., video phones) require a radio access network (RAN) that supports streaming data applications. A streaming data application must be transported over constant bandwidth with low delay and low levels of jitter. However, current wireless networks, such as cdma2000 RANs, often experience problems when supporting streaming data applications. Packet data transmissions between a base station (BS) and a mobile station (MS) experience delay and jitter at numerous points in the network, including at the air interface between the MS and the BS and at the interface between the BS and the packet data serving node (PDSN).

Delays and jitter would be minimized if streaming data could be transmitted more directly between mobile stations, without passing through some infrastructure of the radio access network (RAN), such as the PDSN. However, the well-known RAN signaling messages specified in TIA-2001-C, “Interoperability Specification For Cdma2000 Access Network Interfaces”, June 2003, (hereafter, simply “the TIA-2001-C standard”) and other standards do not provide for direct mobile station-to-mobile station (MS-MS) packet data calls. The TIA-2001-C standard only allows for mobile originated packet data calls. Mobile calls that terminate at a mobile station are not possible under current standards.

U.S. Patent Application Serial No. 20020077096 to Jin (hereafter, the “Jin application”) discloses a method for providing mobile station-to-mobile station (MS-MS) data calls, provided the same base station (BS) serves both mobile stations. The method disclosed in the Jin application establishes MS-MS packet data calls without requiring connections between the BS and the PDSN. However, as noted, the mobile stations must be located in cells served by a single base station. This may be acceptable in a small wireless network that uses a single base station (e.g., a home or small office network). However, if a wireless network operator deploys a RAN with many base stations, this is a severe limitation. Subscribers who are distant from each other are served by different base stations and cannot engage in a MS-to-MS streaming data application without going through the PDSN and a wide area packet data network.

The shortcomings of the Jin application are partially overcome by the apparatuses and methods disclosed in: 1) U.S. patent application Ser. No. 10/695,595, entitled “System And Method For Performing Handoffs Of Mobile Station-To-Mobile Station Packet Data Calls In A Wireless Network,” filed on Oct. 28, 2003, and 2) U.S. patent application Ser. No. 10/695,232, entitled “System And Method For Establishing Mobile Station-To-Mobile Station Packet Data Calls Directly Between Base Stations Of A Wireless Network,” filed on Oct. 28, 2003. application Ser. Nos. 10/695,595 and 10/695,232 disclose wireless network infrastructure and mobile stations that are capable of establishing and handing off MS-MS packet data calls for two mobile stations that are served by different base stations, provided that both base stations are served by the same mobile switching center (MSC). Compared to the Jin application, the systems and methods disclosed in application Ser. Nos. 10/695,595 and 10/695,232 greatly increase the geographical area in which direct MS-MS packet data calls may be established. Nonetheless, the systems and methods in application Ser. Nos. 10/695,595 and 10/695,232 are not capable of establishing MS-MS packet data calls between an originating mobile station operating in a first wireless networks (i.e., operating from a first mobile switching center) and a terminating mobile station operating in a second wireless networks (i.e., operating from a second mobile switching center).

Therefore, there is a need for apparatuses and method that provide an MS-MS packet data connection across different wireless networks. In particular, there is a need for apparatuses and methods that establish an MS-MS packet data connection from an originating base station operating via a first mobile switch center (MSC) to a terminating base station operating via a first mobile switch center (MSC).

### SUMMARY OF THE INVENTION

The present invention enables two cdma2000 wireless networks to quickly connect two mobile stations that require a streaming data flow (e.g., a video phone call).

To address the above-discussed deficiencies of the prior art, it is a primary object of the present invention to provide, for use in a telecommunication system, a method of establishing a packet data session from an originating mobile station (MS) operating in a first wireless network to a terminating mobile station (MS) operating in a second wireless network. According to an advantageous embodiment, the method comprises the steps of: i) receiving in an originating base station (BS) of the first wireless network a packet data connection request transmitted by the originating MS; ii) transmitting a phone number of the terminating MS from the originating BS to an originating mobile switching center (MSC) of the first wireless network; iii) transmitting a first message containing the phone number of the terminating MS from the originating MSC to a terminating mobile switching center (MSC) of the second wireless network via a switched telephone network; and iv) transmitting a second message from the terminating MSC to the terminating MS via a terminating base station of the second wireless network, the second message informing the terminating MS that a packet data session with the originating mobile station is being established.

According to one embodiment of the present invention, the method further comprises the step of establishing a first packet data bearer connection from the originating BS to an IP network via an originating packet data serving node (PDSN) of the first wireless network.

According to another embodiment of the present invention, the method further comprises the step of transmitting a mobile IP address of the originating MS from the originating BS to a server associated with the IP network via the first packet data bearer connection.

According to still another embodiment of the present invention, the method further comprises the step of transmitting the phone number of the terminating MS from the originating BS to the server associated with the IP network via the first packet data bearer connection.

According to yet another embodiment of the present invention, the method further comprises the step of establishing a second packet data bearer connection from the terminating BS to the IP network via a terminating packet data serving node (PDSN) of the second wireless network.

According to a further embodiment of the present invention, the method further comprises the step of transmitting a mobile IP address of the terminating MS from the terminating BS to the server associated with the IP network via the second packet data bearer connection.

According to a still further embodiment of the present invention, the method further comprises the step of transmitting the phone number of the terminating MS from the terminating BS to the server associated with the IP network via the second packet data bearer connection.

According to a yet further embodiment of the present invention, the method further comprises the step of transmitting a first reply message from the server to the originating MS via the first packet data bearer connection, the first reply message containing the mobile IP address of the terminating MS.

In one embodiment of the present invention, the method further comprises the step of transmitting a second reply message from the server to the terminating MS via the second packet data bearer connection, the second reply message containing the mobile IP address of the originating MS.

In another embodiment of the present invention, wherein the originating MS and the terminating MS use the mobile IP addresses received from the server to establish the packet data session between the originating MS and the terminating MS via the IP network.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates a wireless network that can establish an MS-MS packet data connection between mobile stations served by different mobile switching centers according to the principles of the present invention;

FIG. 2 illustrates a telecommunication system in which a mobile station-to-mobile station packet data connection may be established between two wireless networks according to the principles of the present invention; and

FIG. 3 is a flow diagram illustrating the establishment of a mobile station-to-mobile station packet data session according to the principles of the present invention.

### DETAILED DESCRIPTION OF THE INVENTION

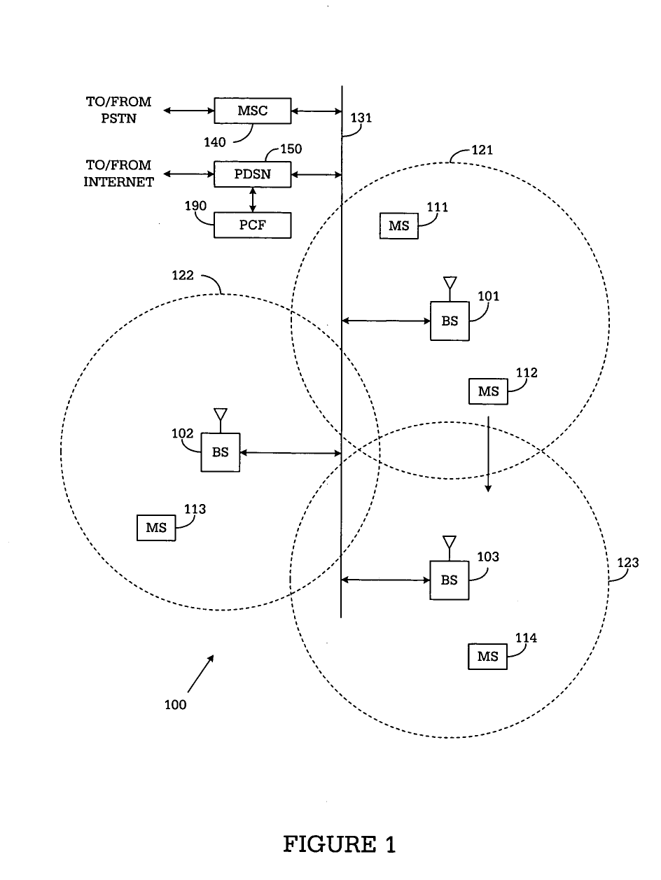

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless communication network.

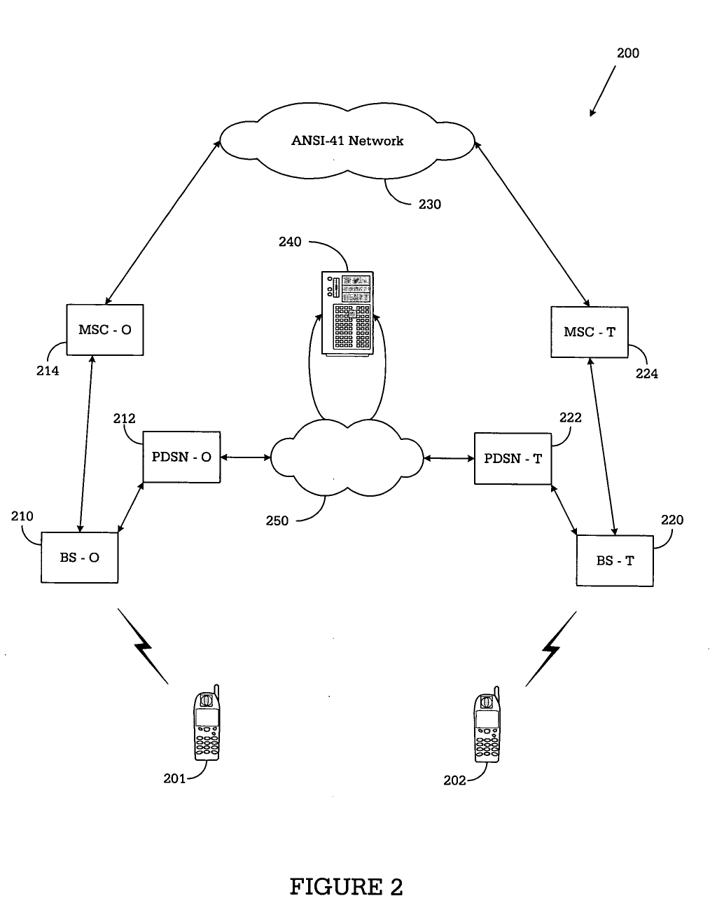

FIG. 1 illustrates exemplary wireless network 100, which can be used in a telecommunication system that establishes an MS-MS packet data connection between mobile stations served by different mobile switching centers according to the principles of the present invention. The telecommunication system would require two wireless networks similar to wireless network 100, as explained in detail in FIG. 2 below. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to the IS-2000-C standard (i.e., Release C of cdma2000). Mobile stations 111-114 may be any suitable wireless devices, including conventional cellular radiotelephones, PCS handset devices, personal digital assistants, portable computers, telemetry devices, and the like, which are capable of communicating with the base stations via wireless links.

The present invention is not limited to mobile devices. Other types of wireless access terminals, including fixed wireless terminals, may be used. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., monitoring devices with wireless capability).

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), where a directional antenna coupled to the base station illuminates each sector. The embodiment of FIG. 1 illustrates the base station in the center of the cell. Alternate embodiments position the directional antennas in corners of the sectors. The system of the present invention is not limited to any particular cell site configuration.

In one embodiment of the present invention, BS 101, BS 102, and BS 103 comprise a base station controller (BSC) and at least one base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122, and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of base stations 101-103, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, or any other type of data connection. The connections on line 131 may transmit analog voice signals or digital voice signals in pulse code modulated (PCM) format, Internet Protocol (IP) format, asynchronous transfer mode (ATM) format, or the like. According to an advantageous embodiment of the present invention, line 131 also provides an Internet Protocol (IP) connection that transfers data packets between the base stations of wireless network 100, including BS 101, BS 102 and BS 103. Thus, line 131 comprises a local area network (LAN) that provides direct IP connections between base stations without using PDSN 150.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a handoff will occur.

According to the principles of the present invention, the mobile stations in wireless network 100 are capable of executing streaming data applications (e.g., video phone). To facilitate these high-speed applications, the present invention provides a means by which a first (or originating) mobile station operating via a first mobile switching center in a first wireless network can originate a packet data session that is terminated on a second (or terminating) mobile station operating via a second mobile switching center in a second mobile station. This capability does not exist in the prior art systems.

FIG. 2 illustrates telecommunication system 200, in which a mobile station-to-mobile station (MS-MS) packet data connection may be established across two wireless networks according to the principles of the present invention. Telecommunication system 200 provides the MS-MS packet data connection between originating mobile station (MS) 201 and terminating mobile station (MS) 202. Telecommunication system 200 comprises selected portions of a first (or originating) wireless network that receives the original packet data connection request from originating MS 201. The originating wireless network comprises originating base station (BS-O) 210, originating packet data serving node (PDSN-O) 212, and originating mobile switching center (MSC-O) 214. Telecommunication system 200 further comprises selected portions of a second (or terminating) wireless network that terminates the packet data connection at terminating MS 201. The terminating wireless network comprises terminating base station (BS-T) 210, terminating packet data serving node (PDSN-T) 212, and terminating mobile switching center (MSC-T) 214.

Finally, telecommunication system 200 comprises switched network 230, server 240, and Internet protocol (IP) network 250. According to an advantageous embodiment of the present invention, switch network is an ANSI-41-compatible network and IP network 250 is the Internet or a similar wide area network (WAN). As will be explained below in greater detail, originating MSC 214 and terminating MSC 224 initially transfer connection setup information between originating BS 210 and terminating BS 220 via switched network 230. Originating BS 210 and terminating BS 220 then use server 240 to exchange the connection setup information and establish a packet data session through originating packet data serving node 212, IP network 250, and terminating packet data serving node 222.

The present invention assumes the following:
i) The service provider maintains server 240 (or a gateway to server 240), which provides for information exchange between MS 201 and MS 202;
ii) The network entities are as described in the IOS logical model defined in TIA-2000-D and utilize IOS signaling with some minor modifications;
iii) The mobile stations use signaling as defined in TIA-2000-C, with some minor modifications;
iv) Billing for the MS-MS packet data connection call is done at MSC 214 and/or MSC 224 and is based only on air time; and
v) The MS-MS packet data connection does not go dormant (i.e., mobile stations 201 and 202 stay on the traffic channels for the duration of the call).

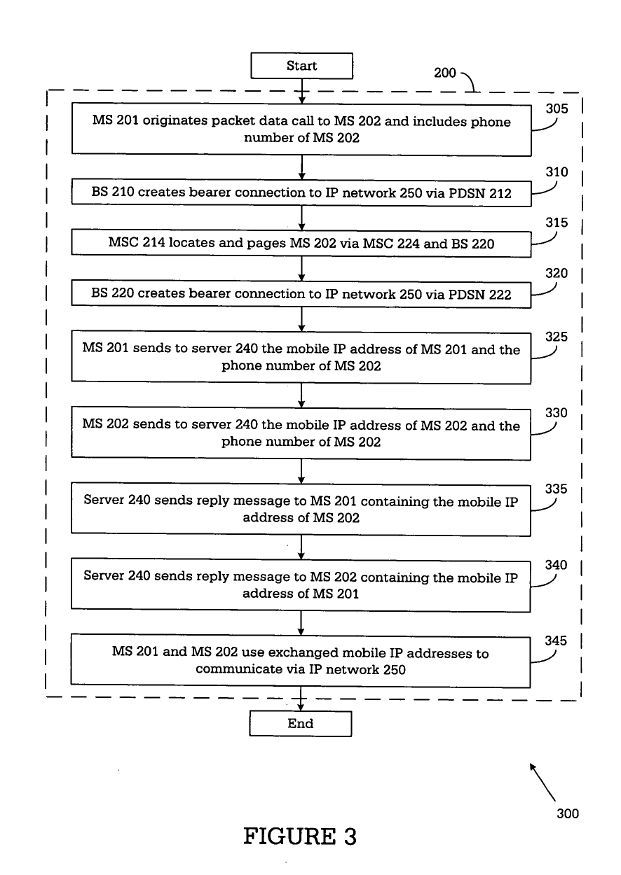

FIG. 3 is a. flow diagram illustrating the establishment of a mobile station-to-mobile station packet data call according to the principles of the present invention. FIGS. 2 and 3 indicate the signaling in the present invention that allows MS-MS packet data session setup. This signaling is based on messages defined in TIA-2000-D and TIA-2000-C, with exceptions as noted.

The operator of originating mobile station 201 initiates a packet data session with the operator of originating mobile station 201. Using the menu on originating mobile station 201, the operator of originating MS 201 selects a MS-MS Packet Data Service option and is prompted to enter the phone number of terminating MS 202. Using the entered phone number, originating MS 201 transmits to BS 210 the control signals needed to page terminating mobile station 202. Originating mobile station 201 may originate the call as a standard Packet Data Service (service option 33), but also includes the phone number of terminating MS 202 to indicate that this is an MS-to-MS packet data call (process step 305). In response, originating base station 210 establishes a bearer connection with originating PDSN 212, as with a conventional packet data call setup (process step 310). BS 210 also establishes a call connection to MSC 214.

Next, originating MSC 214 determines that terminating mobile station 202 is in another wireless network (i.e., locates MS 202) and sends paging request messages over the ANSI-41 network to terminating MSC 224. The paging request messages cause terminating MSC 224 to page terminating mobile station 202. Terminating MSC 224 receives the ANSI-41 messaging indicating an incoming data call. Terminating MSC 224 pages terminating mobile station 202 and establishes a call connection through terminating base station 220. The service option used is S033 (process step 315). Terminating base station 220 then establishes a bearer connection with terminating PDSN 222, as with a conventional packet data call setup (process step 320).

At this point, a first packet data bearer connection exists from originating mobile station 201 to IP network 250 via PDSN 212 and a second packet data bearer connection exists from terminating mobile station 202 to IP network 250 via PDSN 222. As soon as the packet data connection on the originating side is established (i.e., a PPP connection between originating mobile station 201 and originating PDSN 212), originating mobile station 201 sends a message to server 240 indicating the mobile IP address of originating mobile station 201 and the phone number of terminating mobile station 202 (i.e., the called party) (process step 325).

As soon as the packet data connection is established on the terminating side (i.e., PPP connection between terminating mobile station 202 and terminating PDSN 222), terminating mobile station 202 sends a message to server 240 indicating the mobile IP address of terminating mobile station 202 and the phone number of terminating mobile station 202 (i.e., the called party) (process step 330). Once server 240 has received these information messages from both mobile stations, server 240 can send reply messages to each mobile station containing the IP address of the other mobile station (process steps 335 and 340). Server 240 uses the phone number of terminating mobile station 202 (i.e., the called party) as a common identifier for the call. If server 240 does not receive both messages after a fixed time, server 240 initiates a call tear down by indicating to the one mobile station from which server 240 did receive a message that the connection attempt has failed. Normal call teardown then begins, using established messages.

Once each mobile station has received the IP address of the other mobile via a reply message from server 240, the mobile stations may establish a link layer connection (e.g., a PPP tunnel through IP network 250) or begin to exchange application messages directly (process step 345). Originating MS 201 may, for example, request an FTP session on terminating MS 202 or establish an MS-MS video call over the data link.

Call handoffs utilize the same messaging as is presently contained in TIA-2000-D and TIA-2000-C. In the event of an inter-PDSN handoff, the mobile may need to indicate to server 240 that its mobile IP address has changed. This information can then be passed to the other mobile, and the packet data session may continue. Call tear-down utilizes the same messages as packet call tear down in existing cdma2000 systems, and is illustrated in TIA-2000-D and TIA-2000-C.

Although the present invention has been described in detail, those skilled in the art should understand that they may make various changes, substitutions and alterations herein without departing from the spirit and scope of the invention in its broadest form.

1. A method of establishing a packet data session from an originating mobile station (MS) operating in a first wireless network to a terminating mobile station (MS) operating in a second wireless network, the method comprising the steps of:
receiving in an originating base station (BS) of the first wireless network a packet data connection request transmitted by the originating MS;
transmitting a phone number of the terminating MS from the originating BS to an originating mobile switching center (MSC) of the first wireless network;
transmitting a first message containing the phone number of the terminating MS from the originating MSC to a terminating mobile switching center (MSC) of the second wireless network via a switched telephone network; and
transmitting a second message from the terminating MSC to the terminating MS via a terminating base station of the second wireless network, the second message informing the terminating MS that a packet data session with the originating mobile station is being established.

2. The method as set forth in claim 1 further comprising the step of establishing a first packet data bearer connection from the originating BS to an IP network via an originating packet data serving node (PDSN) of the first wireless network.

3. The method as set forth in claim 2 further comprising the step of transmitting a mobile IP address of the originating MS from the originating BS to a server associated with the IP network via the first packet data bearer connection.

4. The method as set forth in claim 3 further comprising the step of transmitting the phone number of the terminating MS from the originating BS to the server associated with the IP network via the first packet data bearer connection.

5. The method as set forth in claim 4 further comprising the step of establishing a second packet data bearer connection from the terminating BS to the IP network via a terminating packet data serving node (PDSN) of the second wireless network.

6. The method as set forth in claim 5 further comprising the step of transmitting a mobile IP address of the terminating MS from the terminating BS to the server associated with the IP network via the second packet data bearer connection.

7. The method as set forth in claim 6 further comprising the step of transmitting the phone number of the terminating MS from the terminating BS to the server associated with the IP network via the second packet data bearer connection.

8. The method as set forth in claim 7 further comprising the step of transmitting a first reply message from the server to the originating MS via the first packet data bearer connection, the first reply message containing the mobile IP address of the terminating MS.

9. The method as set forth in claim 8 further comprising the step of transmitting a second reply message from the server to the terminating MS via the second packet data bearer connection, the second reply message containing the mobile IP address of the originating MS.

10. The method as set forth in claim 9 wherein the originating MS and the terminating MS use the mobile IP addresses received from the server to establish the packet data session between the originating MS and the terminating MS via the IP network.

11. For use in a telecommunication system, a server capable of establishing in an IP network coupled to the server a packet data session between an originating mobile station (MS) operating in a first wireless network and a terminating mobile station (MS) operating in a second wireless network, wherein the server receives a mobile IP address of the originating MS from an originating base station (BS) of the first wireless network via a first packet data bearer connection established between the originating BS and the IP network.

12. The server as set forth in claim 11 wherein the server receives the phone number of the terminating MS from the originating BS via the first packet data bearer connection.

13. The server as set forth in claim 12 wherein the server receives a mobile IP address of the terminating MS from a terminating base station (BS) of the second wireless network via a second packet data bearer connection established between the terminating BS and the IP network.

14. The server as set forth in claim 13 wherein the server receives the phone number of the terminating MS from the terminating BS via the second packet data bearer connection.

15. The server as set forth in claim 13 wherein the server uses the phone number of the terminating MS to match the originating mobile station and the terminating mobile station and to establish the packet data session.

16. The server as set forth in claim 15 wherein the server transmits a first reply message to the originating MS via the first packet data bearer connection, the first reply message containing the mobile IP address of the terminating MS.

17. The server as set forth in claim 16 wherein the server transmits a second reply message to the terminating MS via the second packet data bearer connection, the second reply message containing the mobile IP address of.the originating MS.

18. The server as set forth in claim 17 wherein the originating MS and the terminating MS use the mobile IP addresses received from the server to establish the packet data session between the originating MS and the terminating MS via the IP network.

19. For use in a server coupled to an Internet protocol (IP) network, a method of establishing in the IP network a packet data session between an originating mobile station (MS) operating in a first wireless network and a terminating mobile station (MS) operating in a second wireless network, the method comprising the steps of
receiving a mobile IP address of the originating MS from an originating base station (BS) of the first wireless network via a first packet data bearer connection established between the originating BS and the IP network;
receiving the phone number of the terminating MS from the originating BS via the first packet data bearer connection;
receiving a mobile IP address of the terminating MS from a terminating base station (BS) of the second wireless network via a second packet data bearer connection established between the terminating BS and the IP network; and
receiving the phone number of the terminating MS from the terminating BS via the second packet data bearer connection.

20. The method as set forth in claim 19 further comprising the step of using the phone number of the terminating MS to match the originating mobile station and the terminating mobile station in order to establish the packet data session.

21. The method as set forth in claim 20 further comprising the step of transmitting a first reply message to the originating MS via the first packet data bearer connection, the first reply message containing the mobile IP address of the terminating MS.

22. The method as set forth in claim 21 further comprising the step of transmitting a second reply message to the terminating MS via the second packet data bearer connection, the second reply message containing the mobile IP address of the originating MS.
